(19) United States
(12) Patent Application Publication
(10) Pub. No.: US 2007/0153410 A1
(43) Pub. Date: Jul. 5, 2007

(54) Degaussing for write head

(76) Inventors: Motomu Hashizume, Suginami-ku (JP); Takashi Hirosawa, Tokyo (JP)

Correspondence Address: TEXAS INSTRUMENTS INCORPORATED, P O BOX 655474, M/S 3999, DALLAS, TX, 75265, US

(21) Appl. No.: 11/323,065

(22) Filed: Dec. 30, 2005

(51) Int. Cl. G11B 5/03

(52) U.S. Cl. 360/66

(57) ABSTRACT

A write head degaussing circuit and methodology configured to end the degaussing signal a selectable percentage short of the tapered degaussing waveform, starting the degaussing of the write head current Iw at a percentage less than Iw, removing any overshoot of the degaussing signal, and any combination of the above.

### FIELD OF THE INVENTION

The present invention is generally related to hard disk drives, and more particularly to degaussing a write head.

### BACKGROUND OF THE INVENTION

A hard disk drive typically includes one or more spinning disks stacked above each other on a spindle, a disk drive controller, a rotary actuator and an actuator retract circuit. These elements typically reside in a chassis or housing and are supplied with external cable connectors.

The rotary actuator consists of an arm equipped with a head for reading and writing data in generally radial and concentric tracks in the recording layers of the individual disk. The actuator is usually driven by an attached voice coil motor (VCM). Cables are connected with the actuator to facilitate transmitting signals to and from the head and to power the VCM. The disk drive controller is typically an electronic circuit that controls all functions of the hard disk drive.

During the writing process, the write head coil current Iw direction is changed as a function of the input write data. The write head current typically has an overshoot for better writing, and is controlled by a write head current. Usually, the write head current Iw is shut off during the read process, but some head (pole) holds small magnetization, which magnetization may undesirably cause the erasing of some data. To avoid the unexpected erasing of data, a degaussing process is conventionally performed on the write head after data writing.

There is desired an improved degaussing process to reduce the degaussing time and to maximize the HDD format efficiency.

### SUMMARY OF INVENTION

The present invention achieves technical advantages as a write head degaussing circuit and methodology that ends the degaussing process when the current Iw is selectable percentage short of the tapered degaussing waveform end, starting the degaussing of the write head current Iw at a percentage smaller than Iw, removing any overshoot of the degaussing waveform, and any combination of the above.

### BRIEF DESCRIPTION OF THE DRAWINGS

FIG. 1 is a perspective view of a typical multi-disk drive, wherein each head is positionable across the disk during operation, and also retractable over a ramp to a parking position;

FIG. 2 is an electrical block diagram of a write data driver and degaussing circuit;

FIG. 3 is a diagram of conventional write data and a degaussing Iw waveform;

FIG. 4 is a diagram of a conventional Degauss waveform;

FIG. 5 is a diagram of one preferred embodiment of the invention;

FIG. 6 is a diagram of another preferred embodiment of the invention;

FIG. 7 is a diagram of another preferred embodiment of the invention; and

FIG. 8 is a diagram of another preferred embodiment of the invention.

### DETAILED DESCRIPTION OF THE PRESENT INVENTION

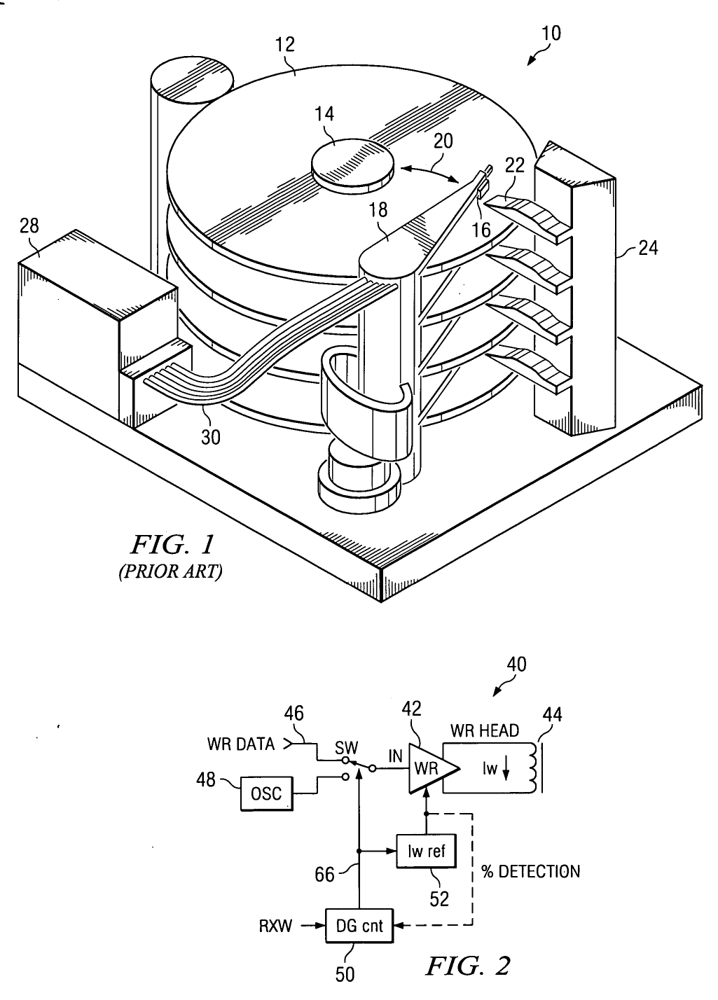

FIG. 1 depicts a conventional hard disk drive 10 having a plurality of disks and associated actuators positionable between an operational position over the disks and a retracted parked position. Each disk 12 is seen to be mounted to a spindle 14 and has associated therewith a head 16 carried by a suspension arm 18. Each head 16 is seen to be positioned via the respective arm 18 across the disk surface as depicted at 20, and is also retractable over a ramp 22 to a parked position distal of the head 22 and over lower portion 24. An actuator control circuit 26 disposed within a housing 28 is coupled to and controls each of the arms 18 via a cable 30.

Referring now to FIG. 2, there is shown a block diagram of a write circuit at 40. Write circuit 40 is seen to include a write head driver 42 driving a voice coil 44, and having an input selectably coupled to either the write data input line 46 or an oscillator 48 via a switch Sw. When the driver input is driven by the oscillator 48, a degaussing controller 50 generates a degaussing signal by modulating the reference current Iw. The degaussing controller 50 also selectively couples and modulates the reference current Iw to create the degaussing signal provided to the input of the write driver 42, as a function of input signal RXW received from the disk drive controller circuit.

Advantageously, according to the present invention, the modulated and tapered write current Iw that is provided to the write driver 42 is also fed back to and monitored by the degaussing controller 50. The degaussing controller 50 monitors this degaussing write current Iw as a form of feedback, and responsively controls the switch SW as will now be described.

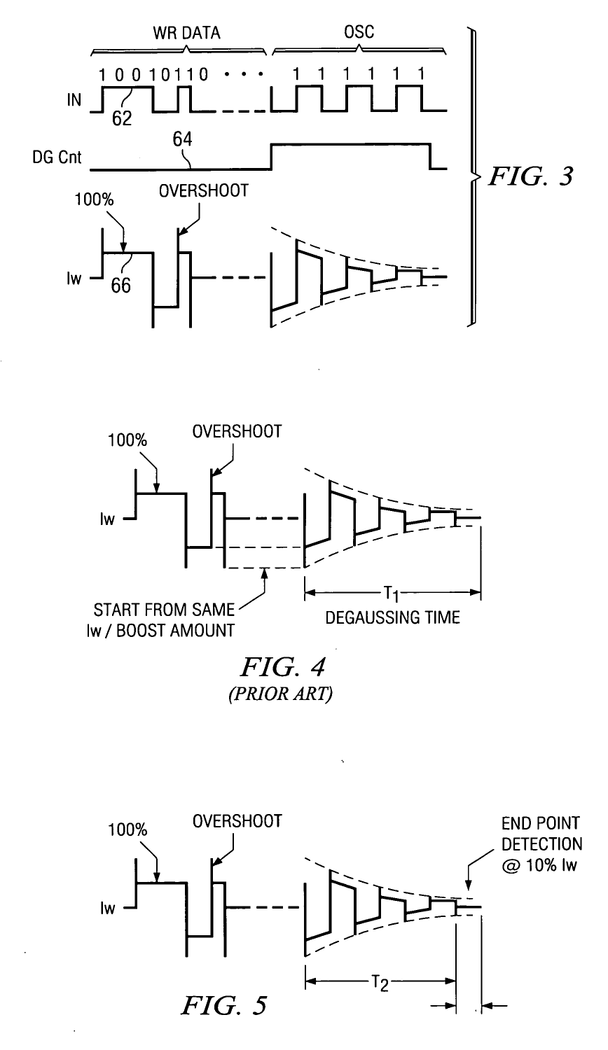

FIG. 3 depicts a conventional write data waveform 62 and the control signal 64 generated by the degaussing controller 50. Also shown in this waveform diagram is a conventional degaussing current Iw 66 as a function of the input data and the degaussing control signal 64, whereby it can be seen that the degaussing write current Iw is tapered from a starting Iw reference current towards 0 when the degaussing control signal 64 is enabled. The degaussing controller 50 generates the control signal 66 for enabling degaussing. In the degaussing mode, the oscillator 48 is connected to the write driver 42, with the write data on line 46 being removed from the write driver 42. The oscillator frequency and the write current Iw tapering time are the basic parameters for the degaussing process.

Referring now to FIG. 4, the conventional degaussing waveform starts from the same write current Iw/boost amount with normal writing, and stops within some period of time T1 when the write current is about 0. This degaussing time T1 is a function of the starting value of the write current Iw.

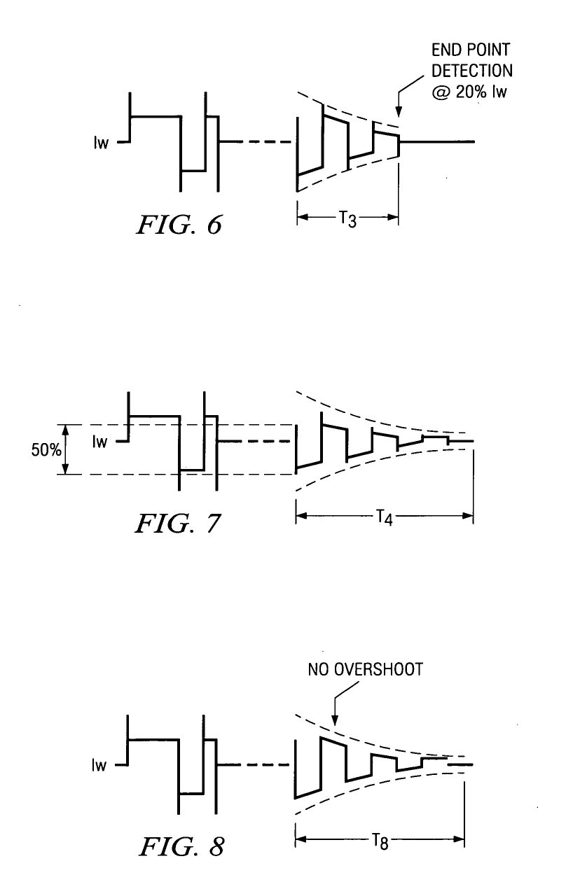

According to the present invention, the degaussing time needed to adequately degauss the write head is reduced, and advantageously maximizing the HDD format efficiency. As depicted in FIG. 5, according to one embodiment of the present invention, the end point of the degaussing waveform is established to be a small percentage of the degaussing current Iw, for instance, 10%. Thus, the degaussing time is reduced to a time T2, where time T2 is less than T1. As shown in FIG. 6, the degaussing waveform may be ended when the degauss current is 20% of Iw, and thus the degaussing time is further reduced to a time T3, which time T3 is less than time T2. The ending point may be fixed, selectable, or variable, and is controlled by degaussing controller 50.

Referring now to FIG. 7, according to yet another embodiment of the present invention, the degaussing waveform may start from a point being less than 100% of the write current Iw, depicted as being about 50% Iw in FIG. 7. Thus, the degaussing time is reduced to a time T4, which time T4 is also substantially less than the conventional degaussing time T1 shown in FIG. 4.

Referring now to FIG. 8, there is shown a further embodiment of the present invention seen to include reducing/eliminating any overshoot of the degaussing waveform, and which waveform may start from a point smaller than the reference current Iw, end a predetermined distance from the end of the tapering, or a combination thereof.

In summary, the present invention comprises an improved degaussing circuit and methodology reducing the time needed to degauss a write head, and increase HDD format efficiency.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications. For instance, the degaussing waveform need not be tapering, and may have some other degaussing waveform. The present invention is also useful in such other modulation waveforms by reducing the starting magnitude of the write current as a function of the reference degaussing current Iw, ending the degaussing a predetermined point from the end of the degaussing waveform, or both.

What is claimed is:

1. A hard disk drive control circuit, comprising:
an input configured to receive write data;
a head driver configured to drive a write head of a hard disk drive with a write head current Iw as a function of the write data; and
a degaussing control circuit configured to selectively couple a degauss signal to the head driver and configured to degauss the write head, wherein the control circuit ends the control signal when the control signal is a predetermined percentage of the write head current Iw.

2. The hard disk drive control circuit as specified in claim 1 wherein the predetermined percentage is at least 10% Iw.

3. The hard disk drive control circuit as specified in claim 1 wherein the predetermined percentage is selectable.

4. The hard disk drive control circuit as specified in claim 1 wherein the control signal starts at less than 100% Iw.

5. The hard disk drive control circuit as specified in claim 1 wherein the control signal has no overshoot.

6. A hard disk drive control circuit, comprising:
an input configured to receive write data;
a head driver configured to drive a write head of a hard disk drive with a write head current Iw as a function of the write data;
a degaussing control circuit configured to selectively couple a degauss signal to the head driver and configured to degauss the write head, wherein the control circuit starts the control signal when control signal is a predetermined percentage of the write head current Iw.

7. The hard disk drive control circuit as specified in claim 6 wherein the control circuit starts communicating the control signal to the write head at less than 100% Iw.

8. The hard disk drive as specified in claim 7 wherein the control signal starts at less than 50% Iw.

9. The hard disk drive as specified in claim 6 wherein the starting percentage of the control signal is selectable.

10. The hard disk drive as specified in claim 6 wherein the control signal ends at least 10% Iw.

11. The hard disk drive as specified in claim 6 wherein the control signal has no overshoot.
